(19) United States
(12) Patent Application Publication
(10) Pub. No.: US 2010/0141397 A1
(43) Pub. Date: Jun. 10, 2010

(54) SYSTEM FOR ACTIVITY RECOGNITION

(76) Inventors: Min Ho KIM, Daejeon (KR); Ho Youl JUNG, Daejeon (KR); Sa Kwang SONG, Daejeon (KR); Jae Won JANG, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/556,711

(22) Filed: Sep. 10, 2009

(30) Foreign Application Priority Data
Dec. 8, 2008 (KR) 10-2008-0123828

(51) Int. Cl. G06K 7/00

(52) U.S. Cl. 340/10.5

(57) ABSTRACT

A sensor-based activity recognition system is disclosed. Activity information is received by using various sensors that can detect activities in daily life and analyzed to recognize daily activities of an individual. A required device can be controlled or relevant information is transferred to a management center according to the recognized daily activity to thus quickly cope with various situations.

### CROSS-REFERENCE TO RELATED APPLICATIONS

This application claims the priority of Korean Patent Application No. 10-2008-0123828 filed on Dec. 8, 2008, in the Korean Intellectual Property Office, the disclosure of which is incorporated herein by reference.

### BACKGROUND OF THE INVENTION

1. Field of the Invention

The present invention relates to a system for recognizing daily activities based on sensors and, more particularly, to a system for activity recognition capable of receiving and analyzing information about individuals' daily activities by using multiple sensors that can sense individuals' activities to recognize the individuals' various daily activities, and rendering assistance to the individuals if necessary.

2. Description of the Related Art

As society develops and human life spans increase, elderly and underprivileged populations are growing. However, in modern society, privacy is increasingly considered to be important and people are becoming less interested in their neighbors, diminishing the amount of assistance or support available to elderly or marginalized people. Thus, elderly and marginalized people increasingly require protection at a societal level, and the need for such protection has stimulated interest in the introduction of a system capable of analyzing and integrally managing the activities of elderly people by using sensors.

In particular, modern society is turning into an aged society due to a rapid increase in aging populations. The aged (i.e., elderly people, senior citizens) have inferior physical abilities for daily activities when compared to those of young adults, so they are easily exposed to emergency situations such as complications arising from chronic diseases, falls, or the like. Thus, demand for easily monitoring elderly people's daily lives is increasing. In modern society, elderly people tend to live independent and stable lives in their houses, rather than in nursing homes, so a technique for monitoring the daily lives of elderly people in their houses is of importance.

Various techniques, such as the following, have been developed to meet such demand.

First, a technique for recognizing a sensor wearer's physical activities by using a linear motion sensor and a rotational motion sensor has been proposed. However, while the sensor wearer's activities, such as walking, running, lying, and the like, can be discriminately recognized with this technique, it is not possible to monitor other daily activities such as having a meal or going to the bathroom (i.e., bowel movements and urination).

Second, a technique for discriminating between urine and feces by using first and second infrared sensors and adjusting the amount of water to be flushed has been developed. This technique allows for the recognition of an individual's excretion activity (i.e., bowel movements and urination) but the accuracy of activity recognition may be degraded due to the use of the infrared sensors. In particular, because the recognition of an individual's activities is not made through excretion patterns, there is the high possibility that while an individual may not have actually performed a bowel movement or urinated, the activity may be recognized as such.

Third, a system for checking personal belongings (i.e., personal item) by recognizing an individual using REID has been developed. That is, when an individual wearing an RFID tag passes through the front door of a dwelling (i.e., the entrance), information about articles required by the individual is provided when the individual goes out or when he returns. However, because this technique does not recognize the patterns of the RFID tag wearer's actual activities, it cannot recognize the individual's actual departures or returns. Namely, even if the individual simply passes through the front door to take out trash, the corresponding activity may be erroneously recognized as a departure.

Finally, a technique for recognizing daily activities using sensors has been proposed. However, an excretion activity recognizer involved in the technique cannot recognize substantial, concrete activities such as discriminating between bowel movements and urination.

### SUMMARY OF THE INVENTION

An aspect of the present invention provides a system for activity recognition capable of accurately recognizing an individual's daily activities by analyzing the individual's daily activity patterns by using signals transferred from sensors installed at locations appropriate for the recognition of daily activities.

Another aspect of the present invention provides a system for activity recognition capable of accurately analyzing an individual's daily activities based on sensors and quickly coping with an emergency situation according to activity analysis results.

According to an aspect of the present invention, there is provided a system for activity recognition including: a sensor reception module configured to recognize an individual from one or more sensors and receive a signal regarding a remaining battery capacity of the sensors; a go-out recognizer configured to recognize whether or not the individual is out by analyzing a time when individual is recognized and the remaining battery capacity; a database configured to store the time when the individual is recognized, the remaining battery capacity, and the information about whether or not the individual is out; and a control unit configured to control an external device according to whether or not the individual is out as recognized by the go-out recognizer.

If a time duration during which the individual is not recognized is longer than a prespecified threshold value and if a finally detected remaining battery capacity is larger than another prespecified threshold value, the go-out recognizer may recognize that the individual is out, and store relevant information in the database.

In the state that the individual is recognized to be currently out based on the relevant information stored in the database, if the individual is recognized, the go-out recognizer may recognize that the individual has returned, and store relevant information in the database.

If the go-out recognizer recognizes the individual's return, the control unit may actuate at least one of a heating apparatus, an air-conditioner, and a lighting equipment.

According to another aspect of the present invention, there is provided a system for activity recognition including: a sensor reception module configured to receive signals detected by an object sensor and a temperature sensor; an excretion recognizer configured to recognize a type of excretion by analyzing signal patterns of the received signals; a database configured to store the recognized type of excretion; and a control unit configured to adjust the amount of water to be flushed in a toilet bowl according to the type of excretion.

If only a temperature change is detected by the temperature sensor, the excretion recognizer may recognize the individual's activity as urination, and if signals are detected by the object sensor and the temperature sensor, the excretion recognizer may recognize the individual's activity as a bowel movement.

The sensor reception module may receive signals from pressure sensors installed at a toilet seat and on the floor.

If the pressure sensor installed on the floor detects signals and then the pressure sensor installed at the toilet seat detects signals, the excretion recognizer may recognize an excretion anticipated activity, and then if the object sensor and the temperature sensor detect signals, the excretion analyzer may recognize the individual's activity as a bowel movement, whereas if only the temperature sensor detects signals, the excretion recognizer may recognize the individual's activity as urination.

According to another aspect of the present invention, there is provided a system for activity recognition including: a sensor reception module configured to receive detect signals from one or more sensors; an activity recognizer configured to analyze signal patterns of the signals which have been detected by the sensor reception module to recognize a particular activity corresponding to the analyzed signal patterns; a database configured to store information about the recognized particular activity; and a control unit configured to transfer a control command corresponding to the recognized particular activity to an external device.

The activity recognizer may include: a pattern recognition unit configured to recognize signal patterns of the detect signals transferred from the sensor reception module; a pattern analysis unit configured to analyze the recognized patterns; and an activity recognition unit configured to recognize a particular activity corresponding to the analyzed patterns.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a system for activity recognition according to an exemplary embodiment of the present invention;

FIG. 2 is a schematic block diagram of a system for activity recognition in relation to the recognition of a state in which an individual is out;

FIG. 3 is a flow chart illustrating the process of a method for recognizing the state in which an individual is out;

FIG. 4 is a schematic block diagram of a system for activity recognition in relation to the recognition of excretion; and

FIG. 5 illustrates the configuration of a toilet bowl with sensors for the recognition of excretion.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

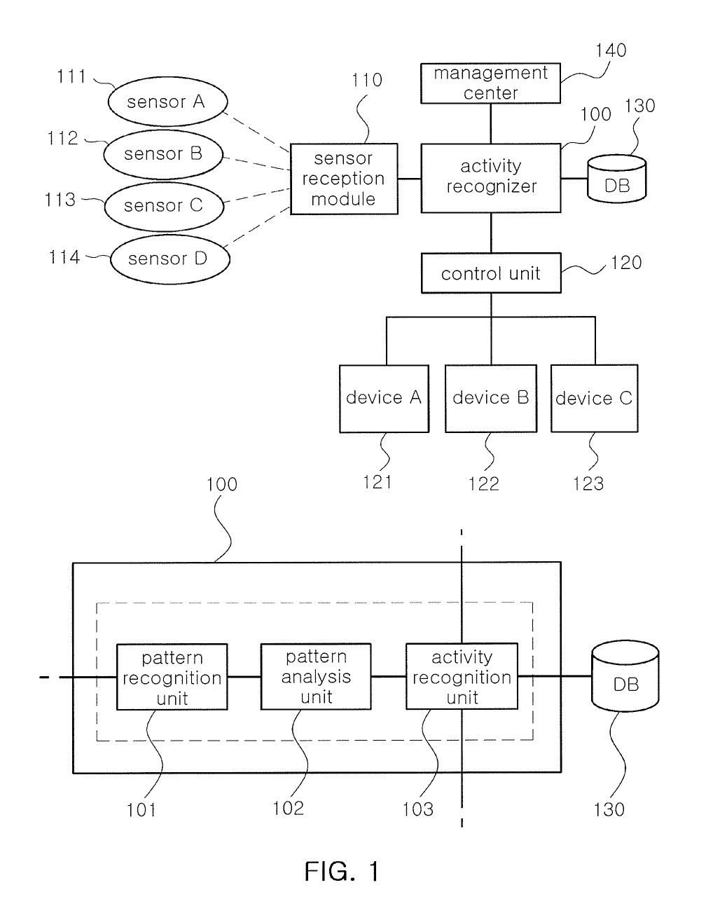

FIG. 1 is a schematic block diagram of a system for activity recognition according to an exemplary embodiment of the present invention.

With reference to FIG. 1, the system for activity recognition is based on one or more sensors 111 to 114. Signals detected by the sensors 111 to 114 are transferred to a sensor reception module 110. The sensor reception module 110 may directly transfer the signals received from the one or more sensors 111 to 114 to an activity recognizer 100, or process the received signals into a proper state and transfer the same to the activity recognizer 100. The activity recognizer 100 analyzes the signals transferred from the sensor reception module 100 to recognize a particular activity. As the particular activity is recognized by the activity recognizer 100, a control unit 120 controls external devices 121 to 123 by a pre-set command, and stores required information in a database (DB) 130. If necessary, the control unit 120 may transfer relevant information to a management center 140 to allow the management center 140 to perform monitoring.

In detail, the system for activity recognition includes one or more sensors. The one or more sensors may vary depending on particular daily activities intended to be recognized through the system for activity recognition. For example, the system for activity recognition may include sensors for detecting whether or not a refrigerator, a rice-cooker, a microwave oven, and the like, is in use to monitor an elderly person's eating activity. A pressure sensor may also be provided in a bed or the like in order to detect how often or for how long an individual sleeps, to thus monitor an individual's sleep state. If an event that an individual goes out is intended to be detected, an individual may attach a sensor for identifying and recognizing an individual. In addition, in order to detect an individual's excretion state, temperature and pressure sensors may be provided as required.

The one or more sensors 111 to 114 may collect information required for recognizing an individual's particular activity and transfer the collected information to the sensor reception module 110.

Upon receiving the signals from the one or more sensors 111 to 114, the sensor reception module 110 transfers the same to the activity recognizer 100. In this case, the sensor reception module 110 may periodically receive signals from the one or more sensors 111 to 114 and transfer them as it is to the activity recognizer 100, or may properly process the received signals and transfer the same to the activity recognizer 100.

The activity recognizer 100 analyzes the signals transferred from the sensor reception module 110 to finally recognize an individual's activity. To recognize an individual's daily activities, the activity recognizer 100 may include a pattern recognition unit 101, a pattern analysis unit 102, and an activity recognition unit 103.

The pattern recognition unit 101 recognizes patterns in the signals transferred from the sensor reception module 100. For example, the pattern recognition unit 101 recognizes the patterns of the signals transferred from a sensor installed in a refrigerator door or a sensor installed in a rice-cooker. The signal patterns may include whether the refrigerator door has been open only once, whether the refrigerator door has been open several times and the rice-cooker has been open, and whether the microwave oven has been used, the rice-cooker has been open, and the refrigerator door has been open several times, and the like. Also, the pattern recognition unit 101 may recognize patterns in the signals received from one or more pressures sensors installed in a bed.

The pattern analysis unit 102 analyzes the recognized signal patterns leading to recognition that the recognized signal patterns denote a particular activity. The pattern analysis unit 102 may analyze patterns such as a detection time of the one or more sensors, the number of detections, the detection order, and the like. For example, the pattern analysis unit 102 may analyze a pattern wherein the refrigerator door has been open only once, or a pattern wherein the refrigerator door has been open several times, the rice-cooker has been open, and the microwave oven has been used. The pattern analysis unit 102 may also analyze a pattern wherein a certain pressure has been detected by the pressure sensor installed in the bed for a certain time duration.

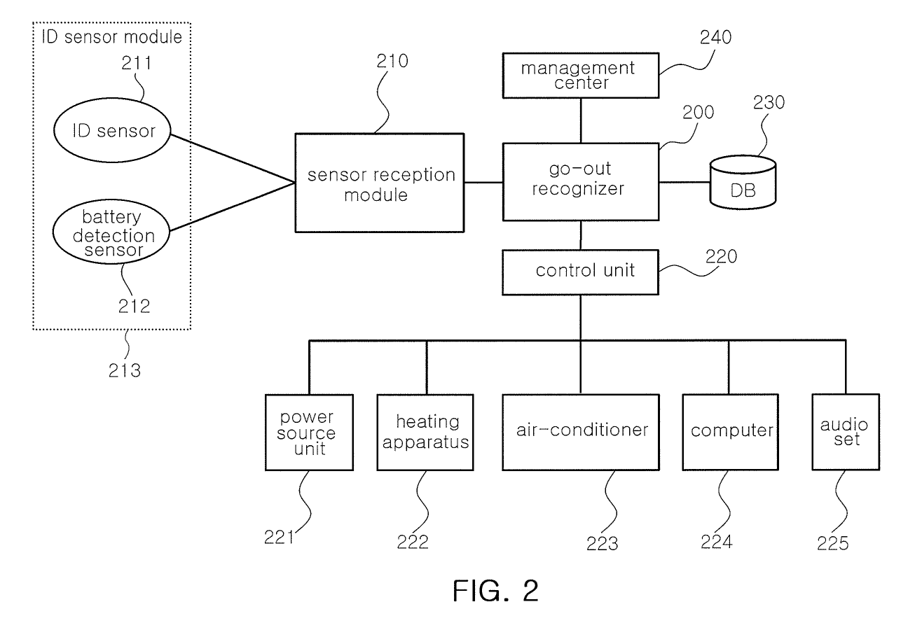

The activity recognition unit 103 recognizes a particular activity corresponding to the patterns analyzed by the pattern analysis unit 102. When the signal patterns are analyzed by the pattern analysis unit 102, the activity recognition unit 103 recognizes a particular daily activity corresponding to the analyzed patterns. For example, the pattern wherein the refrigerator door has been open one time may be recognized as an activity such as simply drinking water or another beverage, rather than an eating activity (having a meal). The pattern wherein the refrigerator door, the rice-cooker, and the microwave oven have been used may be recognized as a meal preparation activity. The signal pattern detected by the pressure sensor installed in the bed during a certain time duration may be recognized as sleep. Recognition of daily activities with respect to going-out and excretion will be described with reference to FIGS. 2 to 5.

Upon detecting a daily activity based on the signals transferred from the sensors, the activity recognizer 100 stores the relevant information in the DB 130. In this case, the activity recognizer 100 may also store information associated with the recognized daily activity. For example, in the case of a sleeping activity, information about a sleeping duration, a time point at which the individual starts sleeping, and the individual's movements during sleeping. In the case of having a meal, information about a meal time and the number of meal times, and the like, may be stored.

When the daily activities are recognized by the activity recognizer 100, the control unit 120 controls pre-set or required external devices 121 to 123. For example, when a sleeping activity is detected, the control unit 120 may execute an alarm function of an alarm unit after a certain time lapses. Also, when the use of the microwave oven is detected, if the microwave oven is continuously used even after a certain lapse of time, the control unit 120 may make an alarm sound for user recognition, and even if no action is taken in spite of the control command, the control unit 120 may stop the operation of the microwave oven. In addition, when the individual goes out (i.e., leaves his place), the control unit 120 may turn off all lighting equipments or stop the operation of the heating apparatus.

The activity recognizer 100 transfers required information to the management center 140. The management center 140 monitors the information transferred from the activity recognizer 100. If the management center 140 determines that a situation is an emergency, or if necessary, the management center 140 may transfer the relevant information to a related agency (or a related organization). For example, if it is determined that an elderly individual has been in an inactive state for a long time period, that he has not had a meal, or that he is sleeping for an excessively extended period of time, then the management center 140 may inform an emergency center accordingly. Hereinafter, a method for recognizing an event whereby an individual goes out of his place or his excretion activity will now be described.

FIG. 2 is a schematic block diagram of a system for activity recognition in relation to the recognition of a state in which an individual is out. Specifically, the system illustrated in FIG. 2 is devised to recognize an event whereby an individual goes out of his place and gets back. The activity recognition system for recognizing the event in which the individual is out includes sensors such as an ID sensor (a sensor module transmitting the signal of the individual's ID) 211 or a battery detection sensor 212, a sensor reception module 210, a go-out recognizer 200 (i.e., a recognizer that recognizes that an individual has gone out so he is absent), a database 230, a management center 240, and a control unit 220. The ID sensor 211 and the battery detection sensor 212 are included a ID sensor module 213.

In detail, the ID sensor 211 transmits an individual ID signal, and the battery detection sensor 212 detects a remaining battery capacity and transfers the detected capacity to the sensor reception module 210. The ID sensor module 213 may be worn directly by an individual, and when the ID sensor module 213 worn by the individual transmits a signal, the sensor reception module 210 receives the signal to recognize the individual. The sensor reception module 210 not only receives the signal transferred from the ID sensor 211 but also recognizes the time at which the signal is received and each individual wearing the ID sensor module 213 through individual identification information. The battery detection sensor 212 transfers information about whether or not a battery has a remaining capacity of the ID sensor module 213.

The sensor reception module 210 receives the signals transferred from the ID sensor 211 and the battery detection sensor 212, and transfers them to the go-out recognizer 200. If necessary, the sensor reception module 210 may process the signals transferred from the ID sensor 211 and the battery detection sensor 212. In FIG. 2, the sensor reception module 210 and the go-out recognizer 200 are separately configured, but if necessary, the function of the sensor reception module 210 may be included in the go-out recognizer 200.

The go-out recognizer 200 analyzes the signals transferred from the sensor reception module 210, namely, the information about the remaining battery capacity detected by the battery detection sensor 212 as well as the individual recognition signal, the signal detected time (i.e., the time at which the signal was detected), and the individual identification information detected by the ID sensor 211, to recognize whether or not the individual is out or is back.

In more detail, if no signal is received from the ID sensor 211 during a certain threshold time duration and a remaining battery capacity of the ID sensor module 213 detected at a point of time when a signal was finally received is larger than a certain threshold value, the go-out recognizer 200 recognizes that the individual is out, and stores required information in the DB 230.

Also, the go-out recognizer 200 stores signals detected when the individual is recognized by the sensor reception module 210, namely, the individual recognition signal, the signal detected time, the individual identification information, and the remaining battery capacity, in the DB 230. Also, if the individual is recognized to be out based on the individual identification information, the go-out recognizer 200 recognizes a currently detected signal as the individual's return activity and stores corresponding information in the DB 230.

If the go-out recognizer 200 recognizes the individual's activity as a daily activity with respect to the event that the individual has been out and is back, it may transfer relevant information to the management center 240 or transfer the relevant information to the control unit 220 to control external devices such as a power source unit 221, a heating apparatus 222, an air-conditioner 223, a computer 224, an audio set 225, and the like.

In more detail, the management center 240 monitors information about the daily activities of the individual. Through such monitoring, if an abnormal activity, such as that the individual never goes out, never gets back after going out, is discovered, the management center 240 may check on the individual through emergency contacts (i.e., an emergency network) or an emergency center. In this manner, an emergency situation that may occur with elderly people may be properly handled.

When the event that the individual is out and gets back is recognized, the control unit 220 may transfer a pre-set or required control command to control an external device. For example, in a state that the individual is recognized to be out, if the heating apparatus is in operation, if a power switch is in an ON state, or if the air-conditioner, the computer, or the audio set is in operation, the control unit 220 may control such external devices to cut off power. The external devices may be set to be controlled by the control unit 220 in various manners.

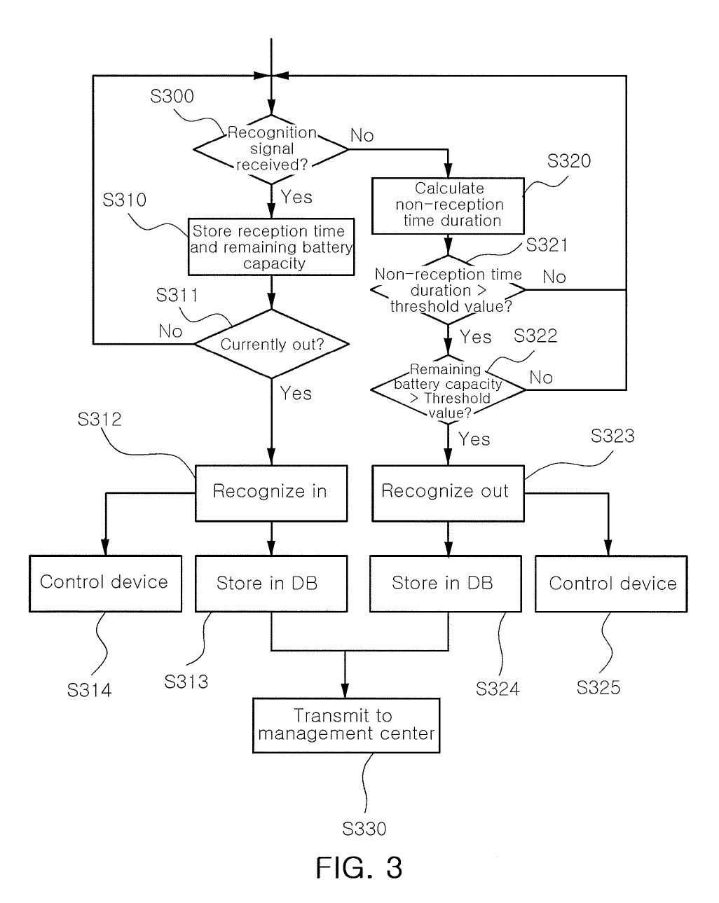

FIG. 3 is a flow chart illustrating the process of a method for recognizing the state in which an individual is out.

The method of recognizing the state that the individual is out in FIG. 3 may be performed in the go-out recognizer 200 of FIG. 2.

The go-out recognizer 200 periodically checks whether or not a signal is received from the sensor reception module 210 (S310). If a signal with respect to a particular individual is not received, the go-out recognizer 200 periodically calculates a non-reception time duration (S320). The non-reception time duration is calculated by comparing a time at which a final signal was received by the ID sensor 211 or the like and a current time.

With the non-reception time duration calculated, it is checked whether or not the calculated non-reception time duration is longer than a prespecified threshold value (S321) If the non-reception time duration is shorter than the threshold value, it is periodically checked again whether or not a signal is received (S300). If the non-reception time duration is longer than the threshold value, it is checked whether or not the remaining battery capacity of the ID sensor module at a point of time when a signal was finally received from the sensor reception module 210 is larger than a prespecified threshold value. If the remaining battery capacity is smaller than the threshold value, whether or not a recognition signal is received is checked again (S300), and if the remaining battery capacity is larger than the threshold value, the go-out recognizer 200 recognizes that the individual is out (S323).

When the individual is recognized to be out, the go-out recognizer 200 stores the relevant information in the DB (S324), controls the eternal devices by means of the control unit 220 (S325), and transmits the relevant information to the management center (S330).

When the go-out recognizer 200 receives a signal with respect to an activity recognition from the sensor reception module 210, it stores the information about the signal reception time and the remaining battery capacity in the DB by using activity recognition information (S311).

The go-out recognizer 200 checks whether or not the individual is recognized to be out by using the information stored in the DB (S311).

If it is determined that the individual is not out (so he is not absent), the go-out recognizer 200 periodically checks whether or not a recognition signal is received (S300).

If it is determined that the individual is out (so he is absent), the go-out recognizer 200 recognizes that the individual will get back (i.e., return) (S312).

The go-out recognizer 200 stores the relevant information in the DB 230 and controls an external device by means of the control unit 220 (S314).

Also, the go-out recognizer 200 transmits the information related to the individual's return to the management center (S330).

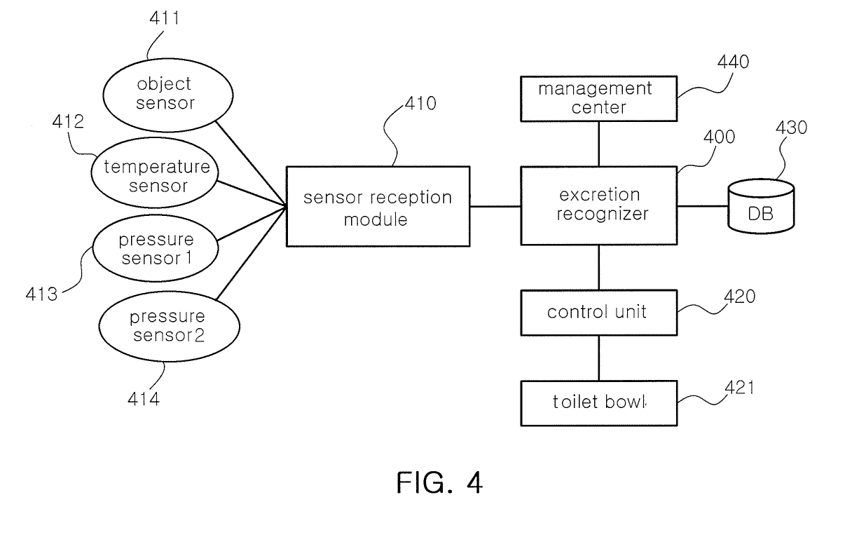

FIG. 4 is a schematic block diagram of a system for activity recognition in relation to recognition of excretion.

The activity recognition system in relation to excretion recognition is based on sensors including an object sensor 411, a temperature sensor 412, a first pressure sensor 413, and a second pressure sensor 414.

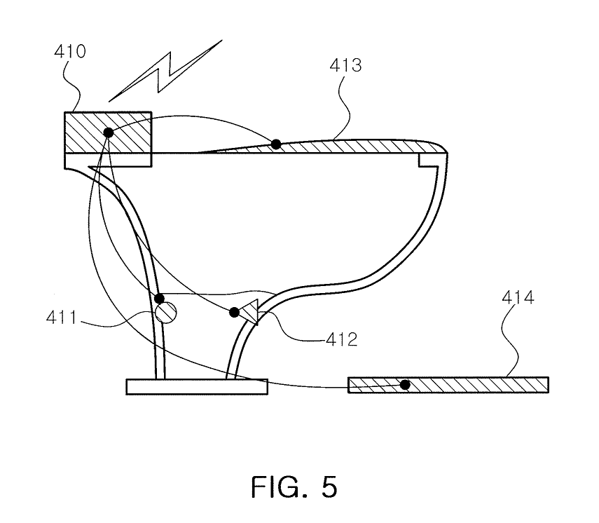

In detail, each sensor may be provided in or around the toilet bowl in such a shape as shown in FIG. 5. The object sensor 411 and the temperature sensor 412 are installed inside the toilet bowl. The object sensor 411 serves to detect a certain lump. Namely, the object sensor 411 may detect an object having a certain volume and mass as well as detecting the feces (solid bodily waste matter). The object sensor 411 may be any type of sensors so long as it can detect such lumps. The temperature sensor 412 detects the temperature of the toilet water. For example, if the individual urinates, the toilet water temperature is bound to rise, so the temperature sensor 412 detects such temperature change in the toilet water.

The first pressure sensor 413 may be installed on a toilet seat, and the second pressure sensor 414 may be installed on the floor in front of the toilet bowl. Namely, when the individual sits on the toilet seat, the first pressure sensor 413 detects a pressure change of the toilet seat, and when the individual stands in front of the toilet bowl or sits on the toilet bowl for urination, the second pressure sensor 414 installed at the position where the individual's feet come detects a pressure change.

The sensor reception module 410 receives signals from the object sensor 411, the temperature sensor 412, the first pressure sensor 413, and the second pressure sensor 414, and transfers the received signals to an excretion recognizer 400.

The excretion recognizer 400 analyzes signals from sensors transferred by the sensor reception module 410 to recognize a daily activity with respect to whether the individual has relieved himself (i.e., a bowel movement or urination) and an excretion type. Of course, the sensor reception module 410 maybe integrally formed with the excretion recognizer 400 and the excretion recognizer 400 may directly receive signals from the sensors 411 to 414.

How the excretion recognizer 400 recognizes excretion based on sensors may be variably set.

For example, an excretion activity may be discriminated by the object sensor 411 and the temperature sensor 412. If only a temperature change is detected by the temperature sensor 412 and no lump is detected by the object sensor 411 based on a received signal, an individual's activity is recognized as urination. If a change in water temperature is detected by the temperature sensor 412 and a lump is detected by the object sensor 411, an individual's activity is recognized as a bowel movement. If no temperature change is detected and only a lump is detected by the object sensor 411, it is recognized that a foreign object has been put into the toilet bowl, rather than the individual's excretion activity.

For another example, the excretion activity may be discriminated by the first and second pressure sensors 413 and 414. If pressure is detected by the second pressure sensor 414 positioned on the floor in front of the toilet bowl and then pressure to the toilet seat is detected by the first pressure sensor 413, an excretion anticipated activity is recognized. And, if a pressure detection time duration (detection end time-detection start time) at the toilet seat by the first pressure sensor 413 is longer than a certain time duration, an excretion activity is recognized. In this case, any additional recognition of the excretion type is not made. If pressure is detected only by the second pressure sensor 414 installed on the floor in front of the toilet bowl and no pressure to the toilet seat is detected by the first pressure sensor 413, the individual's activity may be recognized as male urination.

For still another example, an excretion activity may be recognized by using all of the object sensor 411, the temperature sensor 412, the first pressure sensor 413 and the second pressure sensor 414. In a state that only a temperature change is detected and no lump is detected, if pressure is detected by the first pressure sensor 413 or the second pressure sensor 414 for a certain period of time, it is recognized as an individual's urination activity. If detect signals are generated by the object sensor 411 and the temperature sensor 412 and pressure is detected by the first pressure sensor 413 for more than a certain period of time, it is recognized as an individual's bowel movement activity.

When an individual's activity is recognized as a particular type of excretion by the excretion recognizer 400, the excretion recognizer 400 stores an excretion detection time, a detected activity, individual identification information, and the like, in a DB 430, and transfers relevant information to a management center 440. Of course, the individual identification information may be recognized by an individual identification device provided to each individual.

When the excretion recognition unit 400 recognizes a type of excretion, a control unit 420 controls the toilet bowl 421 to automatically adjust the amount of water flushed for washing the toilet bowl. In detail, if a daily activity is recognized as a bowel movement, the amount of water flushed may be adjusted to be more than that in the case of urination, and for urination, the amount of water flushed may be adjusted to be smaller to save water. In addition, when pressure to the toilet seat is detected by the first pressure sensor 413, the control unit 420 may operate a heating wire to warm up the toilet seat. That is, the control unit 420 may control necessary devices in various manners.

As set forth above, according to exemplary embodiments of the invention, the system for activity recognition has the advantage that an individual's health can be appropriately managed by accurately analyzing daily activities of the individual.

In addition, through a technique that enables the system for activity recognition to accurately recognize whether or not an individual is out, an emergency situation possibly caused as an elderly individual suffering from Alzehimer's is out without permission can be easily coped with, and an individual's health can be periodically checked up by accurately analyzing excretion of the individual.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for activity recognition comprising:
a sensor reception module configured to recognize an individual from one or more sensors and receive a signal regarding a remaining battery capacity of the sensors;
a go-out recognizer configured to recognize whether or not the individual is out by analyzing a time when the individual is recognized and the remaining battery capacity;
a database configured to store the time when the individual is recognized, the remaining battery capacity, and the information about whether or not the individual is out; and
a control unit configured to control an external device according to whether or not the individual is out as recognized by the go-out recognizer.

2. The system of claim 1, wherein if a time duration during which the individual is not recognized is longer than a prespecified threshold value and if a finally detected remaining battery capacity is larger than another prespecified threshold value, the go-out recognizer recognizes that the individual is out, and stores relevant information in the database.

3. The system of claim 1, wherein in the state that the individual is recognized to be currently out based on the relevant information stored in the database, if the individual is recognized by the system, the go-out recognizer recognizes that the individual has returned, and stores relevant information in the database.

4. The system of claim 3, wherein when the go-out recognizer recognizes the individual's return, the control unit actuates at least one of a heating apparatus, an air-conditioner, and a lighting equipment.

5. A system for activity recognition comprising:
a sensor reception module configured to receive signals detected by an object sensor and a temperature sensor;
an excretion recognizer configured to recognize a type of excretion by analyzing signal patterns of the received signals;
a database configured to store the recognized type of excretion; and
a control unit configured to adjust the amount of water to be flushed in a toilet bowl according to the type of excretion.

6. The system of claim 5, wherein if only a temperature change is detected by the temperature sensor, the excretion recognizer recognizes the individual's activity as urination, and if signals are detected by both the object sensor and the temperature sensor, the excretion recognizer recognizes the individual's activity as a bowel movement.

7. The system of claim 5, wherein the sensor reception module receives signals from pressure sensors installed at a toilet seat and on the floor.

8. The system of claim 7, wherein if the pressure sensor installed on the floor detects signals and then the pressure sensor installed at the toilet seat detects signals, the excretion recognizer recognizes an excretion anticipated activity, and then if the object sensor and the temperature sensor detect signals, the excretion analyzer recognizes the individual's activity as a bowel movement, whereas if only the temperature sensor detects signals, the excretion recognizer recognizes the individual's activity as urination.

9. A system for activity recognition comprising:
a sensor reception module configured to receive detect signals from one or more sensors;
an activity recognizer configured to analyze the signal patterns of the signals which have been detected by the sensor reception module to recognize a particular activity corresponding to the analyzed signal patterns;
a database configured to store information about the recognized particular activity; and
a control unit configured to transfer a control command corresponding to the recognized particular activity to an external device.

10. The system of claim 9, wherein the activity recognizer comprises:
a pattern recognition unit configured to recognize signal patterns of the detect signals transferred from the sensor reception module;
a pattern analysis unit configured to analyze the recognized patterns; and
an activity recognition unit configured to recognize a particular activity corresponding to the analyzed patterns.
